(19) United States
(12) Patent Application Publication
(10) Pub. No.: US 2006/0088003 A1
(43) Pub. Date: Apr. 27, 2006

(54) Method and computer program for selecting an inactivity timeout interval based on last data direction

(75) Inventor: John M. Harris, Chicago, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 10/970,628

(22) Filed: Oct. 21, 2004

(51) Int. Cl. H04Q 7/00; H04J 3/17

(52) U.S. Cl. 370/329; 370/433

(57) ABSTRACT

A method and computer program for selecting an inactivity timeout interval for a mobile communications network include steps of: (a) receiving a direction of a last data transfer on a channel resource comprising a reverse link and a forward link allocated by the mobile communications network to a mobile station; (b) when the last data transfer is a forward data transfer, selecting a short inactivity timeout interval for releasing the reverse link wherein the short inactivity timeout interval corresponds to a latency of the mobile station; (c) when the last data transfer is a reverse data transfer, selecting a long inactivity timeout interval for releasing the forward link wherein the long inactivity timeout interval corresponds to a latency of a destination of the reverse data transfer; (d) when a new data transfer occurs between the mobile station and the destination before the selected inactivity timeout interval expires for the last data transfer, continuing from step (a), else (e) releasing the channel resource allocated to the mobile station.

### BACKGROUND OF THE INVENTION

1. Field of the Invention

The method and computer program for selecting an inactivity timeout interval based on last data direction disclosed herein relates generally to mobile communications networks. More specifically, but without limitation thereto, the method and computer program for selecting an inactivity timeout interval based on last data direction disclosed herein relates to a method of releasing a resource channel for a mobile station after a predetermined idle interval.

2. Description of Related Art

A mobile station in a typical mobile communications network waits in a dormant or idle mode when no data is being transferred between the mobile station and a base station. To perform a data transfer from the mobile station to the base station (reverse link or uplink) or a data transfer from the base station to the mobile station (forward link or downlink), a resource channel is allocated to the mobile station by the mobile communications network, and the mobile station is placed in an active mode. The time required to request and allocate the resource channel for the mobile station is called the channel setup delay.

As the data transfer protocols and data transfer rates become more efficient, the channel setup delay has generally decreased from the order of a few seconds to the order of hundreds of milliseconds. When a data transfer between the mobile station and the base station has been completed or has been interrupted for some reason, an inactivity timer is frequently used to release the channel resource if another data transfer is not initiated within a selected inactivity timeout interval. When the resource channel is released, the mobile station is returned to the dormant mode. Releasing the channel resource during periods of inactivity conserves the channel resources available to other mobile stations and reduces battery consumption in the mobile station.

### BRIEF DESCRIPTION OF THE DRAWINGS

The method and computer program for selecting an inactivity timeout interval based on last data direction disclosed herein is illustrated by way of example and not limitation in the accompanying figures, in which like references indicate similar elements throughout the several views of the drawings, and in which:

FIG. 1 illustrates a functional diagram of a mobile communications network according to the prior art;

FIG. 2 illustrates a timing diagram for an inactivity timer of the prior art;

FIG. 3 illustrates a timing diagram of extra channel setup delay in a reverse link data transfer of the prior art resulting from too short an inactivity timeout interval;

FIG. 4 illustrates a flow chart of an exemplary method of selecting an inactivity timeout interval;

FIG. 5 illustrates a timing diagram of a last data transfer on the forward link using the method of FIG. 4;

FIG. 6 illustrates a timing diagram of a last data transfer on the reverse link using the method of FIG. 4; and

FIG. 7 illustrates a timing diagram of a last data transfer on the reverse link using the method of FIG. 4 with a kill switch packet.

Elements in the figures are illustrated for simplicity and clarity and have not necessarily been drawn to scale. For example, the dimensions of some elements in the figures may be exaggerated relative to other elements to point out distinctive features in the illustrated embodiments.

### DESCRIPTION OF THE ILLUSTRATED EMBODIMENTS

The method and computer program for selecting an inactivity timeout interval based on last data direction disclosed herein may be used advantageously, for example, in mobile communications networks such as GPRS (Global Packet Radio Service), GSM (Global System Mobile), CDMA (Code Division Multiple Access), Universal Mobile Telecommunications System (UMTS), and other mobile communications systems that include mobile stations such as cellular telephones and wireless computer devices.

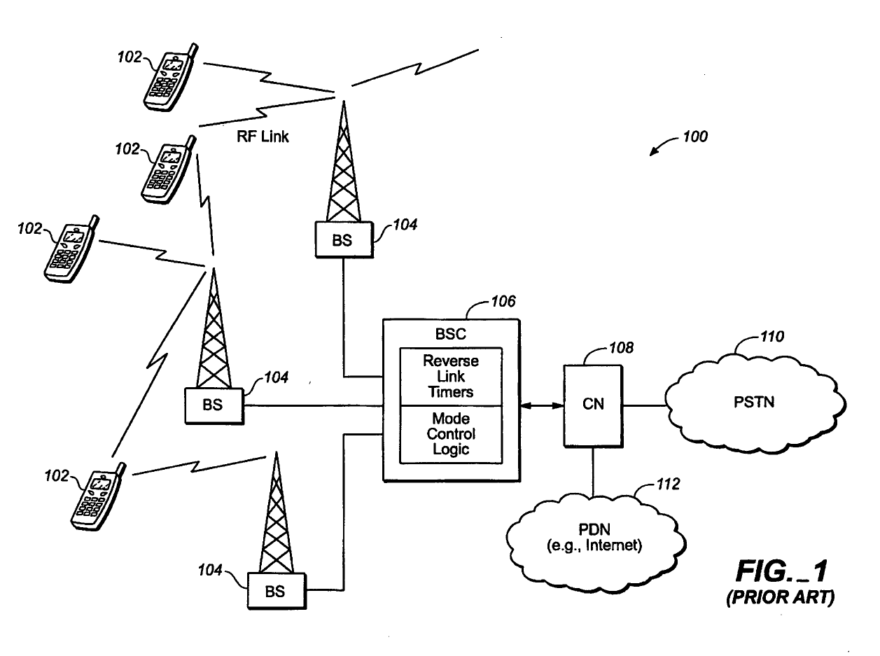

FIG. 1 illustrates a functional diagram of a mobile communications network 100 according to the prior art. Shown in FIG. 1 are mobile stations 102, base stations 104, a base station controller 106, a radio access network (RAN) or core network (CN) 108, a public switch telephone network (PSTN) 110, and a packet data network (PDN) 112.

The mobile communications network 100 includes the mobile stations 102, the base stations 104, the base station controller 106, and the radio access network 108. Each of the mobile stations 102 may be, for example, a cellular telephone or a computer device that includes a central processing unit (CPU) a computer memory, a transmitter, and a receiver. Each of the mobile stations 102 communicates over a radio frequency (RF) link with one of the base stations 104 covering the service area of the corresponding mobile station 102. Each of the base stations 104 is supervised by the base station controller (BSC) 106. The base station controller 106 is connected to the radio access network 108, which provides a gateway, for example, to the public switch telephone network 110 and the packet data network 112. The packet data network 112 may be, for example, the Internet.

To reduce interference and thereby increase system capacity, each of the mobile stations 102 operates in an active mode and a dormant mode. The active mode is used to transfer data between the mobile station 102 and a corresponding base station 104. The dormant mode, also referred to as a control hold mode, is used to suspend use of a channel resource during idle periods when no data transfer occurs between a mobile station 102 and a corresponding base station 104. A channel resource is a dedicated RF link allocated to a mobile station 102 by the base station controller 106.

Communications between a mobile station 102 and a corresponding base station 104 tend to be grouped in time. For example, a mobile station 102 that has recently sent or received a transmission is more likely to receive or send another transmission in the near term than another mobile station 102 that has not sent or received a transmission for some period of time. Exploiting this principle, a mobile station 102 that has recently received or sent a transmission is maintained in the active mode, and a mobile station 102 that has not recently received or sent a transmission is switched to the dormant mode.

One method for switching a mobile terminal 102 from the active mode to the dormant mode uses an inactivity timer that is loaded with a predetermined timeout interval and started at the end of each successful transmission. In a full duplex link such as CDMA, a single inactivity timer is used for both the forward link and the reverse link. In a simplex link, separate inactivity timers are typically used for the forward link and the reverse link. An inactivity timer used for data transfers on the forward link, or forward data transfers, are referred to herein as a forward link inactivity timer. An inactivity timer used for data transfers on the reverse link, or reverse data transfers, are referred to herein as a reverse link inactivity timer. By way of example, an inactivity timer may be implemented by a counter that is loaded with a predetermined value and clocked by a system clock signal to count down to zero in a time period equal to a selected timeout interval. When the zero count is reached, the inactivity timer is said to have timed out, or expired.

If both the forward link and the reverse link inactivity timers for a mobile station 102 have expired, and if there is no data queued for transmission to the mobile station 102, then the base station controller 106 signals the mobile station 102 to enter the dormant mode. Traditionally, the base station controller 106 maintains and manages both the forward link and the reverse link inactivity timers to control the operational modes of the mobile stations 102 within the service area of the base station controller 106. However, the inactivity timers may be implemented by other components of the mobile communications network as well, including the mobile stations 102 and the base stations 104.

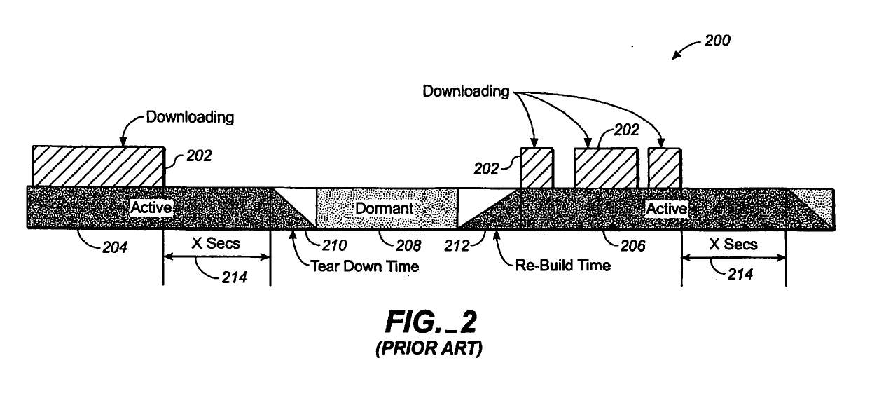

FIG. 2 illustrates a timing diagram 200 for an inactivity timer of the prior art. Shown in FIG. 2 are data transfers 202, active intervals 204 and 206, a dormant interval 208, a channel tear down time 210, a channel setup time 212, and system inactivity timeout intervals 214.

In FIG. 2, data transfers 202 are performed between a mobile station 102 and a base station 104 when a channel resource has been allocated to the mobile station 102. The mobile station 102 is said to be in the active mode indicated by the active interval 204 during the time that the channel resource is dedicated to the mobile station 102. After each data transfer 202, a system inactivity timer is set to the system inactivity timeout interval 214. If no new data transfers have begun when the timeout interval 214 expires, the channel resource is released or torn down during the channel tear down time 210. The mobile station then enters the dormant mode indicated by the dormant interval 208. When new data is ready to transmit, a new channel resource is allocated to the mobile station 102 during the channel setup time 212. At the completion of the channel setup time 212, the mobile station 102 is switched to the active mode indicated by the active interval 206, and data transfers 202 are performed until the system inactivity timer expires at the end of the system inactivity timeout interval 214.

A problem in using inactivity timers lies in selecting the optimum timeout interval as illustrated below.

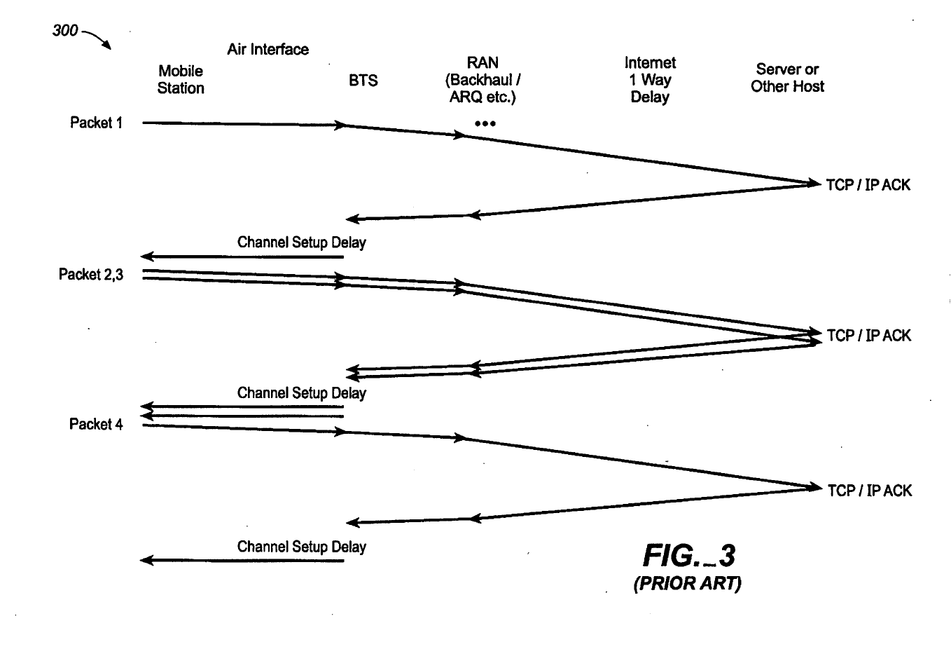

FIG. 3 illustrates a timing diagram 300 of extra channel setup delay in a reverse link data transfer of the prior art resulting from too short an inactivity timeout interval. In the example of FIG. 3, the reverse inactivity timeout interval is set to about one second to allow for various delays through the communications network and the Internet as a data packet is transmitted from a mobile station 102 to a server or other host in the Internet. In this case, the corresponding inactivity timer timeout interval will be too short, and the channel will be reset or torn down and re-established after each data packet transfer. As a result, the channel setup time is added to each data packet transfer, slowing down the overall traffic throughput rate.

The problem of tearing down the channel prematurely in data transfers having alternating directions may be advantageously avoided by selecting a timeout interval for the data direction opposite the direction of the data transfer according to the direction of the last data transfer. That is, if the last data transfer is a forward data transfer, then a short inactivity timeout interval is selected for releasing the reverse link, because the mobile station 102 is generally capable of a quick response for certain types of data transfers, such as automated exchange data transfers used by TCP/IP and other non-streaming transactions. For example, the mobile station latency may be only about 20 to 40 milliseconds for an Internet data transfer. If the last data transfer is a reverse data transfer, however, then a longer inactivity timeout interval is selected for releasing the forward link. This is because the latency of the data destination is typically much longer than for the mobile station, typically several hundred milliseconds to about one second. This method of selecting timeout intervals is generally intended for applications in which small data packets having less than 1,000 bytes of data each are sent in alternating directions, as is frequently encountered with interactive programs and Internet information exchanges.

In one aspect of the method and computer program for selecting an inactivity timeout interval based on last data direction disclosed herein, a method of selecting an inactivity timeout interval for a mobile communications network includes steps of:

(a) receiving a direction of a last data transfer on a channel resource comprising a reverse link and a forward link allocated by the mobile communications network to a mobile station;

(b) when the last data transfer is a forward data transfer, selecting a short inactivity timeout interval for releasing the reverse link wherein the short inactivity timeout interval corresponds to a latency of the mobile station;

(c) when the last data transfer is a reverse data transfer, selecting a long inactivity timeout interval for releasing the forward link wherein the long inactivity timeout interval corresponds to a latency of a destination of the reverse data transfer;

(d) when a new data transfer occurs between the mobile station and the destination before the selected inactivity timeout interval expires for the last data transfer, continuing from step (a), else

(e) releasing the channel resource allocated to the mobile station.

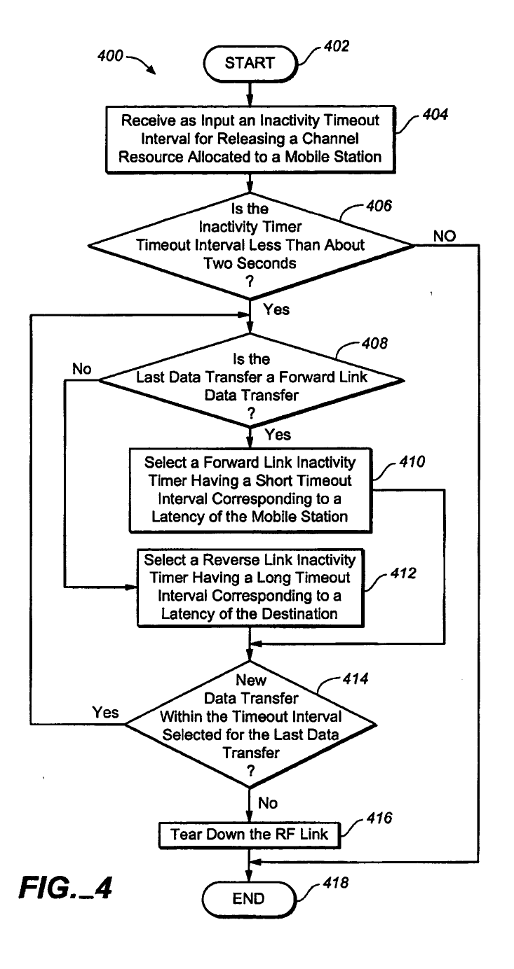

FIG. 4 illustrates a flow chart of an exemplary method of selecting an inactivity timeout interval.

Step 402 is the entry point of the flow chart 400.

In step 404, a default inactivity timeout interval for releasing a channel resource allocated by a mobile communications network to a mobile station is received as input according to well known techniques. The default inactivity timeout interval used by the mobile communications network may vary, for example, due to traffic loading conditions.

In step 406, if the default inactivity timeout interval is less than about two seconds, then there is a substantial risk that the RF link may be torn down during an automated exchange, for example, an Internet data packet transfer or other non-streaming transaction, and the next step continues from step 408. Otherwise, if the inactivity timeout interval is greater than about two seconds, then the RF link is not likely to be torn down during an automated exchange, and the default inactivity timeout interval may be used that does not depend on the direction of the last data transfer. In that case, the next step continues from step 418.

In step 408, if the last data transfer was a forward data transfer, that is, a data transfer from the base station to the mobile station, then the next step continues from step 410. Otherwise, if the last data transfer was a reverse data transfer, that is, a data transfer from the mobile station to the base station, then the next step continues from step 412.

In step 410, a short inactivity timeout interval that corresponds to the latency of the mobile station is selected, and next step continues from step 414. The mobile station can usually respond quickly to generating the next packet in an automated exchange such as an Internet data transfer, and may exhibit a latency in the range from 20 milliseconds to 40 milliseconds. An exemplary short inactivity timeout interval is about 100 milliseconds.

In step 412, a relatively long inactivity timeout interval that corresponds to the latency of the destination, such as a server on the Internet, is selected. The long inactivity timeout interval is selected to ensure that the RF link is not torn down before the automated exchange is complete. Because reverse data transfers are subject to delays due, for example, to paging/slot and page/page response delays in the communications network, the latency of the destination is significantly greater than the mobile station latency. An exemplary long inactivity timeout interval is about one second.

In step 414, if a new data transfer occurs between the mobile station and the base station before the selected inactivity timeout interval expires for the last data transfer, then the next step continues from step 408. If the timeout interval of the selected inactivity timer expires, the next step continues from step 416. An important feature of this method is that only the selected inactivity timeout interval corresponding to the direction of the last data transfer preferably determines whether the channel resource will be released. This means that he channel resource is released if the selected inactivity timeout interval expires, even if an inactivity timer for the other data direction is still running when the selected inactivity timeout interval expires. The release of the channel resource is thereby preferably determined only by the inactivity timeout interval associated with the direction of the last data transfer, regardless of the status of the inactivity timer associated with the opposite data direction.

In step 416, the RF link is torn down, that is, the channel resource allocated to the mobile station is released when the selected inactivity timeout interval expires and the mobile station is switched to the dormant mode.

Step 418 is the exit point of the flow chart 400.

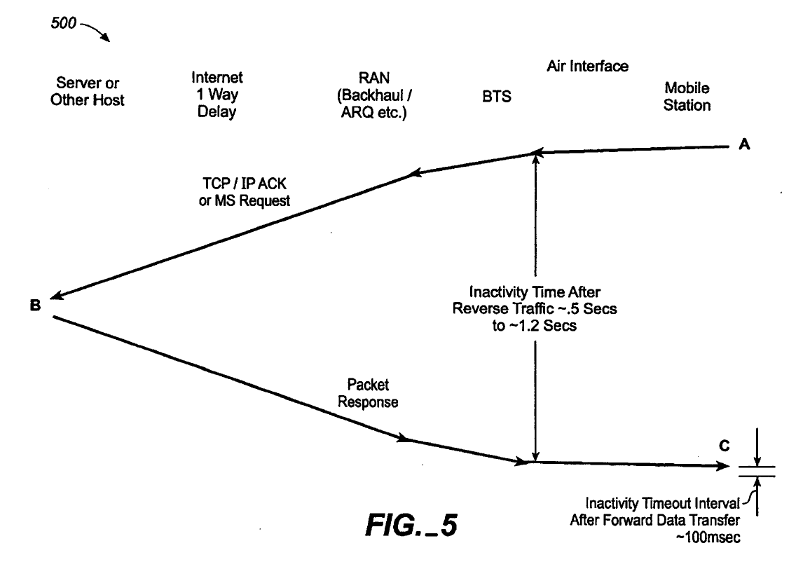

FIG. 5 illustrates a timing diagram 500 of a last data transfer on the forward link using the method of FIG. 4. In FIG. 5, a reverse data transfer packet is sent at A and received at B, and a long timeout interval of about one second is started. A forward data transfer packet is sent at B and received at C, and a short timeout interval of about 100 milliseconds is started. When the short timeout interval expires, the channel resource is released.

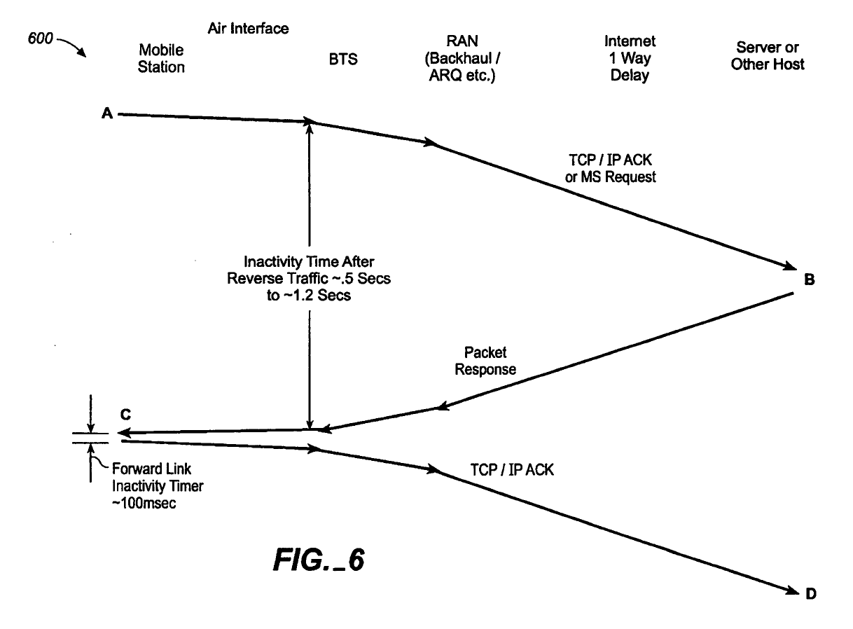

FIG. 6 illustrates a timing diagram 600 of a last data transfer on the reverse link using the method of FIG. 4. In FIG. 6, a reverse data transfer packet is sent at A and received at B, and a long timeout interval of about one second is started. A forward data transfer packet is sent at B and received at C, and a short timeout interval of about 100 milliseconds is started. An acknowledgment is sent on the reverse link to the destination, for example, a server on the Internet, and is received at D. A long timeout interval of about one second is started in anticipation of the next forward data transfer. When the long timeout interval expires, the channel resource is released.

A comparison of FIG. 5 and FIG. 6 suggests that it is preferable to end an automated exchange with the last data transfer on the forward link to exploit the shorter inactivity timeout interval, thereby minimizing the time the channel resource is released following the last data transfer. A rapid release of the channel resource may be initiated, for example, with a “kill switch packet with acknowledgment required” exchange by the mobile station, for example, by “pinging” the server, which is a message from the mobile station that requires a response from the server.

Alternatively, the communications network may generate a “kill switch packet with no acknowledgment required” shortly after sending the last data transfer shortly after sending the last data packet to the mobile station, that is, when enough time has elapsed for the mobile to receive and acknowledge the last data packet.

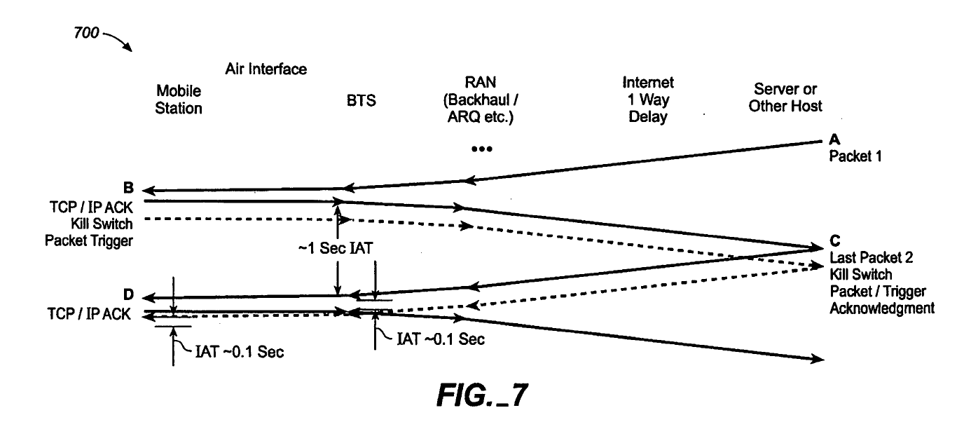

FIG. 7 illustrates a timing diagram 700 of a last data transfer on the reverse link using the method of FIG. 4 with a kill switch packet. A kill switch is a special message used by mobile communications networks to indicate that a channel resource may be released. In FIG. 7, a forward data transfer packet is sent at A and received at B, and a short timeout interval is started. A reverse data transfer packet followed by a kill switch packet trigger are sent at B and received at C, and a long timeout interval is started. A forward data transfer packet and the kill switch acknowledgment are sent at C and received at D, and a short inactivity timeout interval is started. The mobile station acknowledges the forward data transfer packet and sends an acknowledgment on the reverse link, however, the kill switch acknowledgment is received immediately after sending the reverse link acknowledgment, so the short inactivity timeout interval releases the channel resource instead of the longer timeout interval. The kill switch packet is generally not generated unless the communications network detects that the server to mobile station round trip time is large, for example, about one second or more, because it is not worthwhile to expend the resources required to send the kill switch packet for shorter round trip times.

Although the methods illustrated by the flowchart descriptions above are described and shown with reference to specific steps performed in a specific order, these steps may be combined, sub-divided, or reordered without departing from the scope of the claims. Unless specifically indicated herein, the order and grouping of steps is not a limitation of the methods disclosed herein.

The methods illustrated in the flowchart description above may be embodied in a computer program product and implemented by a computer according to well known programming techniques.

While the methods herein disclosed have been described by means of specific embodiments and applications thereof, numerous modifications and variations may be made thereto by those skilled in the art without departing from the scope of the following claims.

What is claimed is:

1. A method of selecting an inactivity timeout interval for a mobile communications network comprising:
(a) receiving a direction of a last data transfer on a channel resource comprising a reverse link and a forward link allocated by the mobile communications network to a mobile station;
(b) when the last data transfer is a forward data transfer, selecting a short inactivity timeout interval for releasing the reverse link wherein the short inactivity timeout interval corresponds to a latency of the mobile station;
(c) when the last data transfer is a reverse data transfer, selecting a long inactivity timeout interval for releasing the forward link wherein the long inactivity timeout interval corresponds to a latency of a destination of the reverse data transfer;
(d) when a new data transfer occurs between the mobile station and the destination before the selected inactivity timeout interval expires for the last data transfer, continuing from step (a), else
(e) releasing the channel resource allocated to the mobile station when the selected inactivity timeout interval expires.

2. The method of claim 1 wherein the long inactivity timeout interval is about one second and the short inactivity timeout interval is about 100 milliseconds.

3. The method of claim 1 wherein the last data transfer is a non-streaming data transfer.

4. The method of claim 4 wherein the last data transfer comprises a TCP/IP data packet.

5. The method of claim 1 wherein the last data transfer is sent to the mobile station.

6. The method of claim 5 wherein the mobile station pings an Internet server after the last data transfer to initiate rapid release of the channel resource.

7. The method of claim 5 wherein the destination sends a kill switch packet to the mobile station to initiate rapid release of the channel resource.

8. The method of claim 1 wherein the channel resource comprises a radio link between the mobile station and the base station.

9. The method of claim 8 wherein the mobile communications network is one of Global Packet Radio Service, Global System Mobile, Code Division Multiple Access, Universal Mobile Telecommunications System, and other mobile communications systems that include mobile stations such as cellular telephones and wireless computer devices and equivalents thereof.

10. The method of claim 1 wherein the mobile station comprises one of a telephone and a computer device.

11. A computer program product for selecting an inactivity timeout interval for a mobile communications network comprising a medium for embodying a computer program for input to a computer and a computer program embodied in the medium for causing the computer to perform steps of:
(a) receiving a direction of a last data transfer on a channel resource comprising a reverse link and a forward link allocated by the mobile communications network to a mobile station;
(b) when the last data transfer is a forward data transfer, selecting a short inactivity timeout interval for releasing the reverse link wherein the short inactivity timeout interval corresponds to a latency of the mobile station;
(c) when the last data transfer is a reverse data transfer, selecting a long inactivity timeout interval for releasing the forward link wherein the long inactivity timeout interval corresponds to a latency of a destination of the reverse data transfer;
(d) when a new data transfer occurs between the mobile station and the destination before the selected inactivity timeout interval expires for the last data transfer, continuing from step (a), else
(e) releasing the channel resource allocated to the mobile station when the selected inactivity timeout interval expires.

12. The computer program of claim 11 wherein the long inactivity timer timeout interval is about one second and the short inactivity timer timeout interval is about 100 milliseconds.

13. The computer program of claim 11 wherein the last data transfer is a non-streaming data transfer.

14. The computer program of claim 14 wherein the last data transfer comprises a TCP/IP data packet.

15. The computer program of claim 11 wherein the last data transfer is sent to the mobile station.

16. The computer program of claim 16 wherein the mobile station pings an Internet server after the last data transfer to initiate rapid release of the channel resource.

17. The computer program of claim 12 wherein the destination is a server that sends a kill switch packet with acknowledgment required to the mobile station after the last data transfer to initiate rapid release of the channel resource.

18. The computer program of claim 11 wherein the channel resource comprises a radio link between the mobile station and the base station.

19. The computer program of claim 18 wherein the mobile communications network comprises one of Global Packet Radio Service, Global System Mobile, Code Division Multiple Access, Universal Mobile Telecommunications System, and other mobile communications systems that include mobile stations such as cellular telephones and wireless computer devices and equivalents thereof.

20. The computer program of claim 11 wherein the mobile station comprises one of a telephone and a computer device.
